(19) United States
(12) Patent Application Publication
(10) Pub. No.: US 2023/0363468 A1
(43) Pub. Date: Nov. 16, 2023

(54) CONCEALER SYSTEMS AND METHODS

(71) Applicant: HBI Branded Apparel Enterprises, LLC, Winston-Salem, NC (US)

(72) Inventor: Michael D. Abbott, Statesville, NC (US)

(21) Appl. No.: 18/315,743

(22) Filed: May 11, 2023

Related U.S. Application Data
(60) Provisional application No. 63/364,543, filed on May 11, 2022.
(60) Provisional application No. 63/385,923, filed on Dec. 2, 2022.

(51) Int. Cl. A41C 3/12; B32B 5/02; B32B 5/26; B32B 7/09; B32B 27/40; B32B 27/28; B32B 27/12; B32B 3/30; B32B 3/26

(52) U.S. Cl. CPC A41C 3/12; B32B 5/02; B32B 5/26; B32B 7/09; B32B 27/40; B32B 27/283; B32B 27/12; B32B 3/30; B32B 3/263; B32B 2307/7376; B32B 2255/02; B32B 2255/10

(57) ABSTRACT

A brassiere including a concealer is provided. The brassiere comprises a body portion configured to at least partially encircle a torso of a wearer of the brassiere. Breast cups comprising a first breast cup and a second breast cup are coupled to the body portion and configured to support breasts of the wearer. Each of the first breast cup and the second breast cup comprise a first layer of fabric and a concealer coupled to the first layer of fabric. The concealer comprises a polymer including a body having a first thickness value at or proximate to a center of the body and a second thickness value at or proximate to a periphery of the body. The first thickness value is greater than the second thickness value. The polymer is screen printed, digitally printed, laser sintered, or extruded onto the first layer of fabric.

### CROSS-REFERENCE TO RELATED APPLICATIONS

This application claims priority to U.S. Provisional Patent Application Ser. No. 63/364,543, filed on May 11, 2022, entitled “MODESTY CONCEALER,” currently pending, and U.S. Provisional Patent Application Ser. No. 63/385,923, filed on Dec. 2, 2022, entitled “LASER SINTERING SYSTEM AND METHOD,” currently pending, the entire disclosures of which are incorporated herein by reference.

### FIELD OF INVENTION

The present disclosure relates generally to garments and more specifically to brassieres including concealers coupled to breast cups of the brassieres.

### BACKGROUND

Brassieres for everyday wear should offer comfort, support, and coverage to the wearer. For many consumers, such comfort arises in knowing that particular portions of their breasts (e.g., an areola region) are not visible underneath their clothing. As such, some brassieres are provided with breast cups including relatively thick layers of foam or other materials that may provide a contoured and modest appearance. However, such thick layers of foam significantly increase the weight and bulk of the brassiere, which can be uncomfortable for some wearers. In comparison, other brassieres constructed out of thin or sheer fabrics do not provide consumers with their desired level of discretion or coverage, which can lead to embarrassment for those consumers. When wearing such brassieres, the consumers may resort to inserting additional materials as “padding” into the breast cups of the brassiere, which represents an additional expense and hassle for the consumers. Further, the additional materials may cause chafing if the additional materials are positioned between the consumers' skin and the breast cups for prolonged periods of time.

To solve these issues, some brassiere manufacturers have turned to constructing brassieres into which foam inserts can be inserted into the breast cups of the brassieres, the foam inserts designed to provide a desired level of coverage for the consumers' areola region. However, such pads are uncomfortable for some consumers and are inconvenient because the consumers must place the foam inserts into the breast cups each time they desire to utilize the foam inserts. Other brassiere manufacturers have attempted to provide brassieres including polymers that can provide a desired level of coverage for the consumers' areola region. Unfortunately, traditional methods of applying polymers to the brassieres are a labor and resource-intensive process that significantly increases the cost of the brassieres. In some instances, polymers are bonded to the garment using an adhesive, representing a significant cost for the manufacturers as specialized equipment must be used to apply the adhesive to the garment and/or polymer. Furthermore, a substantial portion of the polymer is wasted during the polymer application process, which yet further increases the cost of manufacturing the garments. Moreover, traditional polymers provided in brassieres are visible underneath the consumers' clothing, reducing or eliminating the coverage the polymer purports to provide.

### SUMMARY

The present systems and methods overcome many of the shortcomings and limitations of the prior art devices discussed above. The systems described include several embodiments of concealers for breast cups of brassieres utilizing polymers (e.g., urethane, silicone, or plastisol) applied to an area proximate or adjacent to an apex region of the breast cup. The concealers may be defined by a thickness that decreases from a center region of the concealer to the concealer's periphery, and the periphery may be an irregular and/or broken pattern. Advantageously, the thickness and the peripheral pattern provide concealment for wearers.

The concealer may be applied or coupled to the breast cups of the brassieres in a variety of manners including, but not limited to, screen printing, digital printing, laser sintering, injection molding, or extrusion. As such, the systems and methods described herein further include a laser sintering apparatus provided with a sintering laser that is configured to apply or couple the concealer to a fabric comprising the breast cups.

In one aspect, a brassiere including a first breast cup and a second breast cup configured to support breasts of a wearer is provided. Each of the first breast cup and the second breast cup is provided in the form of a first layer of fabric and a concealer coupled to an outer surface or an inner surface of the first layer of fabric. The concealer includes at least one polymer, and the concealer has a varying thickness between a first thickness value at a center of the concealer and a second thickness value at a periphery of the concealer.

In some embodiments, the at least one polymer may be provided as at least one of urethane, polyurethane, silicone, or plastisol. For example, the at least one polymer may be provided in the form of a water-based polymer. As an additional example, the at least one polymer may be provided in the form of a thermoplastic elastomer. As yet another example, the at least one polymer may be provided in the form of polyurethane.

In other embodiments, the center area may be provided as a substantially elliptical, a substantially circular, or a substantially ovular shape. For example, the center area may be provided in the form of a substantially circular shape.

In yet other embodiments, the periphery of the concealer may include an irregular, non-circular pattern.

In some embodiments, the first thickness value may be about 3 mm to about 0.02 mm. For example, the first thickness value may be less than about 3 mm, or less than about 2 mm, or less than about 1 mm, or less than about 0.5 mm, or less than about 0.1 mm, or less than about 0.05 mm, or less than about 0.02 mm.

In other embodiments, the second thickness value may be about or substantially zero millimeters.

In yet other embodiments, the first thickness value is greater than the second thickness value. For example, the first thickness value may be between about 0.025 mm and about 2.5 mm, and the second thickness value may be about zero millimeters. The center of the concealer may include a center area with the first thickness value.

In some embodiments, the varying thickness of the concealer may gradually decrease from the first thickness value to the second thickness value. For example, the varying thickness of the concealer may taper from the center to the periphery of the concealer.

In other embodiments, the brassiere may include a body portion that at least partially encircles a wearer of the brassiere. For example, the body portion may include a torso band to at least partially encircle a wearer of the brassiere.

In some embodiments, each of the first breast cup or the second breast cup may include a second layer of fabric positioned in an overlapping configuration with the first layer of fabric. For example, the second layer of fabric may be positioned against the outer surface of the first layer of fabric and the concealer such that the first layer of fabric and the second layer of fabric surround the concealer. In such embodiments, the concealer may be coupled to an inner surface of the second layer of fabric. In other embodiments, the second layer of fabric may be positioned against the inner surface of the first layer of fabric and the concealer such that the first layer of fabric and the second layer of fabric surround the concealer. In such embodiments, the concealer may be coupled to an inner surface of the second layer of fabric.

In other embodiments, the first layer of fabric may include at least one of polyester, nylon, viscose, cellulosic fabric, spandex, or thin urethane foam.

In yet other embodiments, the at least one polymer of the concealer may be at least one of screen printed, digitally printed, laser sintered, or extruded onto the first layer of fabric. For example, the at least one polymer may be laser sintered onto the first layer to couple the concealer thereto.

In another aspect, a breast cup for a brassiere includes a first fabric layer and a concealer. The concealer may be coupled to an outer surface of the first fabric layer or an inner surface of the first fabric layer. The concealer includes a polymer, and the concealer has a varying thickness between a first thickness value adjacent to a center of the concealer and a second thickness value adjacent to a periphery of the concealer. In some embodiments, the first thickness value may be greater than the second thickness value. In other embodiments, the concealer may be coupled to the inner surface of the first fabric layer.

In some embodiments, the polymer may be provided as at least one of urethane, polyurethane, silicone, or plastisol.

In other embodiments, the polymer may be provided as a water-based polymer.

In yet other embodiments, the polymer may be provided as a thermoplastic elastomer. In such embodiments, the thermoplastic elastomer may include polyurethane.

In some embodiments, the varying thickness of the concealer may gradually decrease from the first thickness value to the second thickness value.

In other embodiments, the second thickness value may be about zero millimeters or substantially zero millimeters.

In yet other embodiments, the first thickness value may be between 0.025 mm (0.001 inches) and 2.5 mm (0.1 inches).

In some embodiments, the center of the concealer may include a center area of the concealer with the first thickness value. In such embodiments, the center area may be provided as or include an elliptical, a circular, or an ovular shape.

In other embodiments, the periphery of the concealer may be provided in an irregular, non-circular pattern.

In yet other embodiments, the breast cup may further include a second fabric layer positioned in an overlapping configuration with the first fabric layer. For example, the second fabric layer may be positioned against the outer surface of the first fabric layer and the concealer such that the first fabric layer and the second fabric layer surround the concealer. In some such embodiments, the concealer may be coupled to an inner surface of the second fabric layer. The second fabric layer may be positioned against the inner surface of the first fabric layer and the concealer such that the first fabric layer and the second fabric layer surround the concealer.

In some embodiments, the first fabric layer and/or the second fabric layer may include at least one of polyester, nylon, viscose, cellulosic fabric, spandex, or thin urethane foam.

In other embodiments, the polymer of the concealer may be at least one of screen printed, digitally printed, laser sintered, or extruded onto the first fabric layer and/or the second fabric layer.

In yet another aspect, a method of forming a breast cup for a brassiere is provided. The method may comprise applying a concealer to an outer surface or an inner surface of a first fabric layer of a breast cup. The concealer may comprise a polymer, and the concealer may have a varying thickness between a first thickness value at a center of the concealer and a second thickness value at a periphery of the concealer, wherein the first thickness value is greater than the second thickness value.

In some embodiments, applying the concealer may include screen printing the polymer of the concealer to the outer surface or the inner surface of the first fabric layer.

In other embodiments, applying the concealer may include laser sintering the polymer of the concealer to the outer surface or the inner surface of the first fabric layer.

In yet other embodiments, applying the concealer may include extruding the polymer of the concealer to the outer surface or the inner surface of the first fabric layer.

In some embodiments, applying the concealer may include digitally printing the polymer of the concealer to the outer surface or the inner surface of the first fabric layer.

In other embodiments, the polymer may include at least one of urethane, polyurethane, silicone, or plastisol. For example, the polymer may include a water-based polymer. As an additional example, the polymer may include silicone, and the method may include adding a catalyst to the silicone before applying the concealer to the outer surface or the inner surface of the first fabric layer. As yet another example, the polymer may include a thermoplastic elastomer. In such embodiments, the thermoplastic elastomer may include polyurethane.

In yet other embodiments, applying the concealer to the outer surface or the inner surface of the first fabric layer may include gradually varying a thickness of the concealer from the first thickness value to the second thickness value. The second thickness value may be substantially zero.

In some embodiments, applying the concealer to the outer surface or the inner surface of the first fabric layer may include directly applying the concealer to the outer surface or the inner surface of the first fabric layer.

In other embodiments, the method may include attaching a second fabric layer against the outer surface of the first fabric layer and the concealer such that the first fabric layer and the second fabric layer may surround the concealer.

In yet other embodiments, the method may include attaching the concealer to an inner surface of the second fabric layer.

In some embodiments, the method may include attaching a second fabric layer against the inner surface of the first fabric layer and the concealer such that the first fabric layer and the second fabric layer may surround the concealer.

In one aspect, a brassiere is provided. The brassiere comprises a body portion configured to at least partially encircle a torso of a wearer of the brassiere. The body portion is coupled to a pair of breast cups. The breast cups may comprise a first breast cup and a second breast cup configured to provide support to the breasts of the wearer. Each of the first and second breast cups may comprise a first layer of fabric and a concealer coupled to the first layer of fabric. The concealer comprises a polymer provided in the form of a body that varies in thickness between a first thickness value (at or proximate to a center of the concealer) and a second thickness value (at or proximate to a periphery of the concealer). The first thickness value may be greater than the second thickness value. In some embodiments, the polymer is screen printed, digitally printed, laser sintered, or extruded onto the first layer of fabric.

In other embodiments, the brassiere may further comprise a second layer of fabric positioned against an inner surface of the first layer of fabric and the concealer. The first layer of fabric and the second layer of fabric may be coupled via an attachment mechanism. In such embodiments, the first layer of fabric and the second layer of fabric may surround the concealer. In addition, the concealer may be coupled to a surface of the second layer of fabric.

In some embodiments, each of the first breast cup and the second breast cup of the brassiere may further include an apex region. In such embodiments, the concealer may be positioned at or proximate to the apex region.

In other embodiments, the polymer may comprise at least one of urethane, polyurethane, silicone, or plastisol. In yet other embodiments, the polymer may comprise a composition that is capable of being laser sintered to a fabric.

In some embodiments, the first thickness value may be about 3 mm to about 0.02 mm. For example, the first thickness value may be less than about 3 mm, or less than about 2 mm, or less than about 1 mm, or less than about 0.5 mm, or less than about 0.1 mm, or less than about 0.05 mm, or less than about 0.02 mm.

In other embodiments, the second thickness value may be about or substantially zero millimeters.

In yet other embodiments, the first thickness value may be less than about 3 mm, the second thickness value may be about zero millimeters, and the concealer may taper from the center to the periphery.

In some embodiments, the center of the concealer may be provided in the form of a substantially circular shape, a substantially ovular shape, or a substantially elliptical shape. The periphery of the concealer may be provided in the form of a substantially irregular, non-circular shape or pattern.

In yet other embodiments, after the polymer is applied to the first layer of fabric, the polymer may be laser sintered by a laser sintering apparatus. In such embodiments, the laser sintering may couple the polymer to the first layer of fabric.

In another aspect, a breast cup for a brassiere is provided. The breast cup comprises a first fabric layer and a concealer coupled to the first fabric layer. The concealer may comprise a polymer composition. In some embodiments, the concealer is provided in the form of a body having a center and a periphery. The concealer may have a first thickness value proximate or adjacent to the center and a second thickness value proximate or adjacent to the periphery.

In some embodiments, the first thickness value may be about the same or greater than the second thickness value.

In other embodiments, a thickness of the concealer may taper from the first thickness value to the second thickness value or from the second thickness value to the first thickness value.

In yet other embodiments, the first thickness value may be no greater than about 3 mm and the second thickness value may be less than the first thickness value.

In some embodiments, the center of the concealer may be provided in the form of a first shape and the periphery of the concealer may be provided in the form of a second shape. In some such embodiments, the first shape may be different from the second shape.

In other embodiments, the body of the concealer may further comprise a plurality of first protrusions having a first length and a plurality of second protrusions having a second length. In some such embodiments, first ends of the plurality of first protrusions and second ends of the plurality of second protrusions may have gaps positioned therebetween, and the gaps may be substantially devoid of the polymer composition.

In some embodiments, the body of the concealer may include voids substantially free of the polymer composition. In some such embodiments, a density of the voids may increase from the center and toward the periphery of the body.

In other embodiments, the breast cup may further comprise a second fabric layer including an inner surface and an outer surface. In some such embodiments, the inner surface of the second fabric layer may be coupled to an inner surface of the first fabric layer via stitching, bonding, or an adhesive. In yet other embodiments, the concealer may be coupled to the inner surface of the second fabric layer at or near an apex of the breast cup.

In yet another aspect, a method of forming a breast cup of a brassiere is provided. The method comprises the steps of providing a first fabric layer, the first fabric layer including an outer surface and an inner surface. The method further includes the steps of providing a polymer, applying a concealer to the outer surface or the inner surface of the first fabric layer, and curing the polymer to couple the polymer to the outer surface or the inner surface of the first fabric layer.

In some embodiments, the polymer may be applied to the outer surface or the inner surface of the first fabric layer with a varying thickness.

In other embodiments, the method of forming a breast cup of a brassiere may further comprise the step of coupling a second fabric layer to the first fabric layer. In some such embodiments, the first fabric layer and the second fabric layer may substantially surround the concealer after the second fabric layer is coupled to the first fabric layer.

In yet other embodiments, after the polymer is applied to the outer surface or the inner surface of the first fabric layer, or after the polymer is cured, the polymer may have a first thickness value near a center portion of the polymer and a second thickness value near a periphery of the polymer. The polymer may taper from the first thickness value to the second thickness value.

In some embodiments, the method of forming a breast cup of a brassiere may further comprise the step of providing a center portion of the concealer in a first pattern and a periphery of the concealer in a second pattern. In other embodiments, the first pattern may be substantially elliptical or substantially ovular. In yet other embodiments, the second pattern may be substantially irregular.

In some embodiments, the method of forming a breast cup of a brassiere may further comprise the step of providing a laser sintering apparatus including a polymer coater and a sintering laser. The polymer coater may be adapted to retain the polymer until the polymer is applied to the first fabric layer. In such embodiments, the step of providing the polymer may be carried out by the polymer coater. In other embodiments, the polymer may be cured when a laser of the sintering laser strikes the polymer.

In another aspect, a laser sintering apparatus is provided. The apparatus comprises at least one fabric roll adapted to provide at least one fabric. The apparatus may further comprise a polymer dispensing mechanism including a body and a dispenser, the body adapted to retain at least one polymer, and the dispenser adapted to provide the at least one polymer to a first fabric of the at least one fabric. The apparatus may also include at least one sintering laser positioned and located above a portion of the first fabric, and a controller in electrical communication with the at least one sintering laser. The controller may be adapted to execute programming to control the at least one sintering laser such that the at least one sintering laser creates a sintered polymer having a predetermined pattern on the first fabric. In some embodiments, the predetermined pattern may include a center region having a first thickness value and a periphery region having a second thickness value.

In one aspect, a method for providing a finished fabric or a finished garment having a laser-sintered polymer is provided. The method may comprise the steps of providing a fabric, applying at least one polymer to the fabric, sintering the at least one polymer using a sintering laser, cutting a fabric pattern outline in a predetermined shape, and adhering the fabric to another item of fabric. In some embodiments, the finished garment may be provided in the form of a brassiere including a concealer.

In one aspect, a method for providing a fabric or a garment with a laser-sintered polymer is provided. The method comprises the steps of providing a fabric, applying at least one polymer to the fabric, sintering the at least one polymer using a sintering laser, and cutting a fabric pattern outline in a predetermined shape. In some embodiments, the predetermined shape may be in the form of a breast cup.

In another aspect, a brassiere including a sintered polymer is provided. The brassiere comprises a pair of breast cups defined by a first breast cup and a second breast cup that is configured to support breasts of a wearer. Each of the first breast cup and the second breast cup include a first layer of fabric and a concealer coupled to the first layer of fabric. The concealer comprises a polymer, and the concealer has a varying cross-sectional thickness. A first thickness value is defined at a center of the concealer and a second thickness value is defined at a periphery of the concealer, wherein the first thickness value is greater than the second thickness value. The polymer may be laser sintered via a laser sintering apparatus to couple the polymer to the first layer of fabric. In some embodiments, the laser sintering apparatus sinters the polymer of the concealer in a predetermined pattern, the predetermined pattern creating the varying thickness between the center of the concealer and the periphery of the concealer.

These and other aspects and advantages of the disclosed embodiments will become apparent to those skilled in the art after considering the following detailed description in connection with the accompanying drawings.

### BRIEF DESCRIPTION OF DRAWINGS

FIG. 1 is an isometric view of a brassiere provided on a wearer;

FIG. 2 is a partial rear elevational view of a breast cup of the brassiere of FIG. 1, the breast cup including a concealer constructed according to the teachings herein;

FIG. 3 is a partial cross-sectional view of the breast cup of FIG. 2, the partial cross-sectional view taken along a line 3-3 depicted in FIG. 2;

FIG. 4A is a top plan view of an embodiment of a concealer, the concealer constructed according to the teachings herein;

FIG. 4B is a top plan view of a photographic representation of another example embodiment of a concealer, the concealer constructed according to the teachings herein;

FIG. 5A is a schematic representation of a method for forming a breast cup of a brassiere, the breast cup constructed in accordance with the teachings herein;

FIG. 5B is a schematic representation of another method for forming a breast cup of a brassiere, the breast cup constructed in accordance with the teachings herein;

FIG. 6 is an isometric view of an embodiment of a laser sintering system;

FIG. 7 is an isometric view of another embodiment of a laser sintering system;

FIG. 8 is an isometric view of a further embodiment of a laser sintering system; and

FIG. 9 is a schematic representation of a method that can produce a laser-sintered fabric or garment constructed in accordance with the teachings herein.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

Additionally, while the following discussion may describe features associated with specific devices or embodiments, it is understood that additional devices and/or features can be used with the described systems and methods, and that the discussed devices and features are used to provide examples of possible embodiments, without being limited.

This disclosure describes concealers for garments including breast cups, such as brassieres and other upper body garments (e.g., shirts and athletic wear) having built-in brassieres. The concealers may be provided with any type of bra known in the art, including (but not limited to) full cup, demi-cup, cami, sport, bullet, triangle, plunge, strapless, push-up, minimiser, t-shirt, and soft-cup brassieres. The concealers may incorporate or be comprised of polymers (such as urethane, silicone, and/or plastisol) that are applied proximate to or adjacent to an apex region of the breast cup. When the brassiere is worn in its intended configuration, the concealer generally aligns with the nipple and/or areola of a wearer of the brassiere to help conceal a point of contact between the wearer's nipple and the breast cup. In addition, the polymer of the concealer may provide resistance to the nipple projecting away from the wearer's body and becoming visible from an exterior of the breast cup.

A thickness of a body of the concealer may taper, either from a center of the body to the body's periphery, or from the periphery to the center. The concealer may include an irregular, broken pattern at the periphery to reduce (e.g., blur) the visibility of the concealer from view when the brassiere is worn. The tapering and the irregular periphery of the concealer may help avoid the appearance of a “bullseye” on the breast cups and may help mask the existence of the concealer from an exterior viewer.

The concealer may be coupled to the breast cup or the brassiere, for example, by printing (e.g., screen printing), laser sintering, extrusion, injection molding, or another application method. These methods may include applying the polymer to a fabric of the breast cup and then curing the polymer such that the polymer adheres to or otherwise couples to the fabric of the breast cup.

Generally, unless the context dictates otherwise, the term “outer” refers to a portion of an element that is positioned away from the body or skin of a wearer when the garments of the present disclosure are worn. On the other hand (unless the context dictates otherwise), the term “inner” refers to the portion of an element that is positioned relatively towards the body or skin of a wearer when the garments of the present disclosure are worn. Because the garments may comprise multiple components coupled together, an outer surface of an element may not be visible to an observer since the outer surface may be further covered by additional elements with inner and outer surfaces of their own.

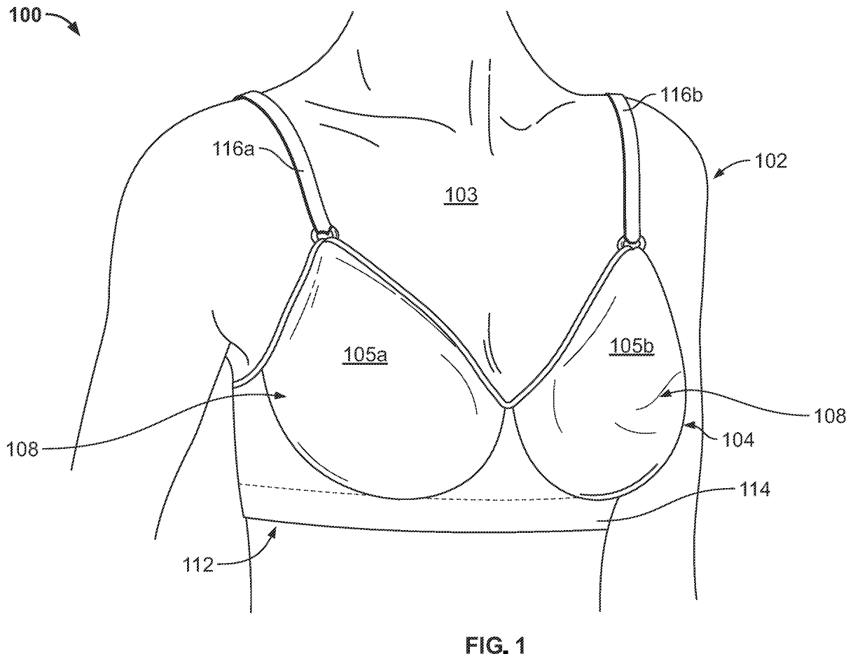

FIG. 1 is an isometric view of an exterior of a brassiere 100 on a wearer 102. Generally, the brassiere 100 is provided in the form of a pair of breast cups 104 coupled to a body portion 112, the body portion 112 further including a torso band 114, side wings (not illustrated), and, optionally, shoulder straps 116a, 116b. The pair of breast cups 104 may be defined by a first breast cup 105a and a second breast cup 105b. Each of the breast cups 105a, 105b may be provided in the form of a convex, parabolic structure designed to cover at least a portion of a breast of the wearer 102 when the brassiere is worn. Further, the pair of breast cups 104 may be configured to support the breasts of the wearer 102 when the brassiere 100 is worn.

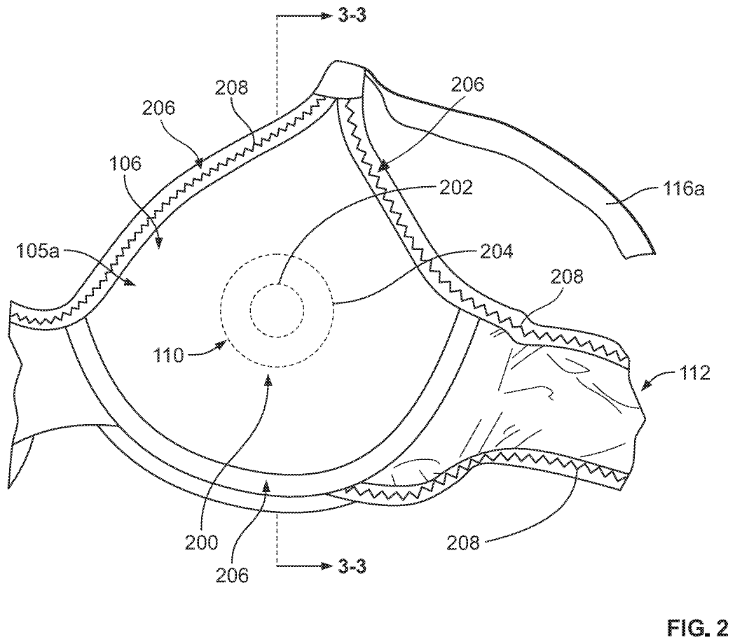

Each of the breast cups 105a, 105b may include a first layer of fabric 106 (see FIG. 2) and a second layer of fabric 108 that partially or completely overlaps the first layer of fabric 106. When the brassiere 100 is worn, the first layer of fabric 106 may be positioned proximate or adjacent to the skin of the wearer 102, and the second layer of fabric 108 may be positioned on the outer portion of the brassiere 100. Each of the breast cups 105a, 105b may include a concealer 110 (see e.g., FIGS. 2, 3, 4A, and 4B) positioned on an outer surface of the first layer of fabric 106. Thus, the concealer 110 may be positioned between the first layer of fabric 106 and the second layer of fabric 108. As will be explained herein, the concealer 110 may be coupled to the first layer of fabric 106 and/or the second layer of fabric 108 via a laser sintering process utilizing an apparatus similar to those embodied by laser sintering apparatuses 600, 700, 800.

The body portion 112 may be configured to partially or completely encircle the torso 103 of the wearer 102. For example, the torso band 114 and/or the side wings may partially or completely encircle the wearer 102 to help the brassiere 100 remain in position on the torso 103. In some instances, the torso band 114 may be provided as an elongated, elastic member configured to help retain the brassiere 100 in position when the brassiere 100 is worn. In other instances, the brassiere 100 may include one or more shoulder straps, such as the shoulder straps 116a, 116b. The shoulder straps 116a, 116b may couple to one or both of the breast cups 105a, 105b, extend over the shoulders of the wearer 102, and couple to a back region (not illustrated) of the body portion 112 (e.g., a back region of the side wings and/or torso band 114). When coupled to the back region, the shoulder straps 116a, 116b may apply an upwardly directed force on the breast cups 105a, 105b to help retain them in position on the wearer 102 and/or to help the brassiere 100 provide support to the breasts of the wearer 102.

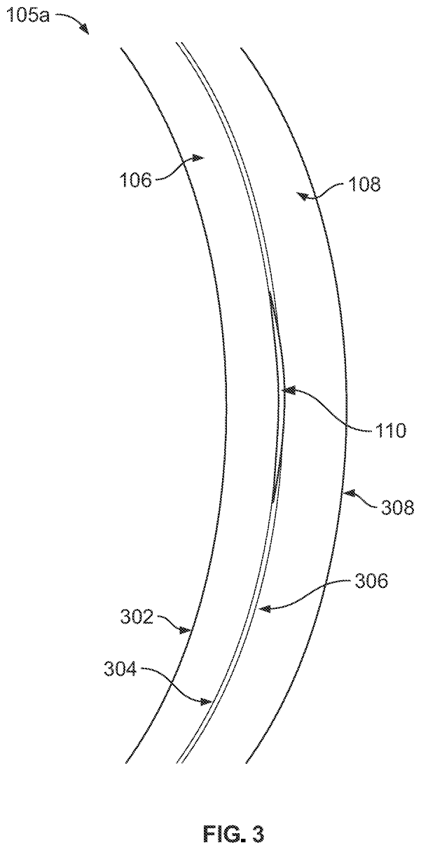

The breast cup 105a illustrated in FIGS. 2 and 3 is a right breast cup, and as can be appreciated, a left breast cup (e.g., second breast cup 105b) may have a structure that substantially mirrors the right cup (e.g., first breast cup 105a). The breast cup 105a may include the first layer of fabric 106, the second layer of fabric 108, and the concealer 110. The concealer 110 may be disposed between the first layer of fabric 106 and the second layer of fabric 108. As best illustrated in FIG. 3, the first layer of fabric 106 includes an inner surface 302 and an outer surface 304, and the second layer of fabric 108 includes an inner surface 306 and an outer surface 308. The concealer 110 may be disposed between the outer surface 304 of the first layer of fabric 106 and the inner surface 306 of the second layer of fabric 108. In some instances, the concealer 110 is applied or coupled to the outer surface 304 of the first layer of fabric 106, and the second layer of fabric 108 acts as a liner material to hide the concealer 110 from view when the brassiere 100 is worn. In other instances, the concealer 110 is applied or coupled to the inner surface 306 of the second layer of fabric 108, and the first layer of fabric 106 acts as a liner between the skin of the wearer 102 and the concealer 110. In yet other instances, the concealer 110 is applied or coupled to both the first layer of fabric 106 and the second layer of fabric 108.

Referring still to FIG. 3, in alternative embodiments, the concealer 110 may be applied or coupled to other fabric surfaces. For example, the concealer 110 may be coupled to the inner surface 302 of the first layer of fabric 106. As an additional example, the concealer 110 may be coupled to the outer surface 308 of the second layer of fabric 108. Further, in embodiments of the breast cups 105a, 105b that include more than two layers of fabric, the concealer may be coupled to any inner surface and/or any outer surface of any fabric layer provided with the breast cups 105a, 105b.

In some embodiments, the breast cup 105a (and/or second breast cup 105b of brassiere 100) may exclude the second layer of fabric 108. In such embodiments, the concealer 110 may not be hidden from view if coupled to the outer surface 304 of the first layer of fabric 106. In some instances, one or more additional plies or layers of fabric may be added between the wearer 102 and the first layer of fabric 106, for example, to increase comfort for the wearer.

In some embodiments, the breast cup 105a (and/or second breast cup 105b of brassiere 100) may include both the first layer of fabric 106 and the second layer of fabric 108. In such embodiments, one or more additional layers of fabric may be added outside of the second layer of fabric 108 to, for example, provide a decorative outer appearance and/or to further mask the visibility of the concealer 110.

The first layer of fabric 106 and the second layer of fabric 108 may be comprised of the same fabric or different fabrics. For example, the first and second layers of fabric 106, 108 may be provided as cotton, polyester, nylon, viscose, cellulosic fabric, spandex, thin urethane foams, a combination of these materials, and/or other natural and synthetic materials. As an additional example, the first and second layers of fabric 106, 108 may be provided as any fabric suitable for coupling to the polymer or polymers comprising the concealer 110.

Turning again to FIG. 2, the first and second fabric layers 106, 108 may be coupled to one another via an attachment mechanism 206 to create one or more seams 208. As illustrated, the seams 208 are positioned and located at the periphery of the bra cup 105a, although the seams 208 may also be positioned elsewhere on the bra cup 105a. Further, in embodiments wherein more than two fabric layers are provided in the bra cup 105a, the attachment mechanism 206 may couple any and/or all of the fabric layers together to create the seams 208. In other instances, the first and second fabric layers 106, 108 may be coupled to one another via bonding, sintering, or through other methods whereby the layers are joined together and the seams 208 may be omitted or not visible, as described in more detail hereinbelow.

The attachment mechanism 206 may be provided in the form of stitching, an adhesive, a bonding mechanism (e.g., ultrasonic bonding, bonding tape, thermal bonding), and/or other suitable attachment mechanisms. In addition, in embodiments wherein the attachment mechanism 206 forms at least one seam 208, the type of seam formed is not particularly limited and may include a flat-locked seam, a fold-over seam, a taped seam, a welt seam, a flat-felled seam, a piped seam, and the like.

In some instances, the bra cup 105a may be provided in a seamless configuration (e.g., via an attachment mechanism 206 that does not create seams 208). For example, the bra cup 105a cup could be created via a bonding process (e.g., using ultrasonic bonding, bonding tape, or thermal bonding methods) or the bra cup 105a may be created via a molding process. In such embodiments, the attachment mechanism 206 may couple the fabric layers forming the bra cup 105a at the periphery of the bra cup 105a or elsewhere on the bra cup 105a.

In some embodiments, the concealer 110 may provide an increased degree of rigidity to an apex region 200 of the breast cup 105a. When the brassiere 100 is worn in its intended configuration by the wearer 102, the apex region 200 may be a portion of the bra cup 105a that extends farthest outwardly and away from the torso 103 of the wearer 102. The concealer 110 may be composed of a polymer having a higher degree of rigidity (e.g., as defined by the amount of force required to bend or deform the polymer) than the rigidity of the first layer of fabric 106 and/or the second layer of fabric 108. In such embodiments, the concealer 110 may have a first rigidity value, the first layer of fabric 106 may have a second rigidity value, and the second layer of fabric 108 may have a third rigidity value. In some instances, the first rigidity value may be greater than the second and third rigidity values. The rigidity of the concealer 110 may provide coverage to the wearer by maintaining a smooth outer contour of the breast cup 105a when the brassiere 100 is worn by the wearer 102.

In some embodiments, the concealer 110 may be provided with a substantially uniform rigidity (e.g., the first rigidity value) or the concealer 110 may be provided with a nonuniform rigidity. In embodiments wherein the rigidity of the concealer 110 is not uniform, areas of the concealer 110 having less polymer material may have a fourth rigidity value that is less than the first rigidity value. For example, the concealer 110 may have a fourth rigidity value in regions that have a smaller or reduced thickness compared to other regions of the concealer 110. Further, in such embodiments, the fourth rigidity value may be greater than or substantially the same as the second and third rigidity values associated with the first and second layers of fabric 106 and 108, respectively.

Referring again to FIG. 2, the apex region 200 may be provided at or near a center portion 201 of the breast cup 105a. However, the apex region 200 may also be provided in other locations on the breast cup 105a as would be appreciated by those skilled in the art. In addition, the apex region 200 may be positioned to overlie a nipple and/or areola area of the torso 103 (or breast) when the wearer 102 is wearing the brassiere 100 in the intended configuration.

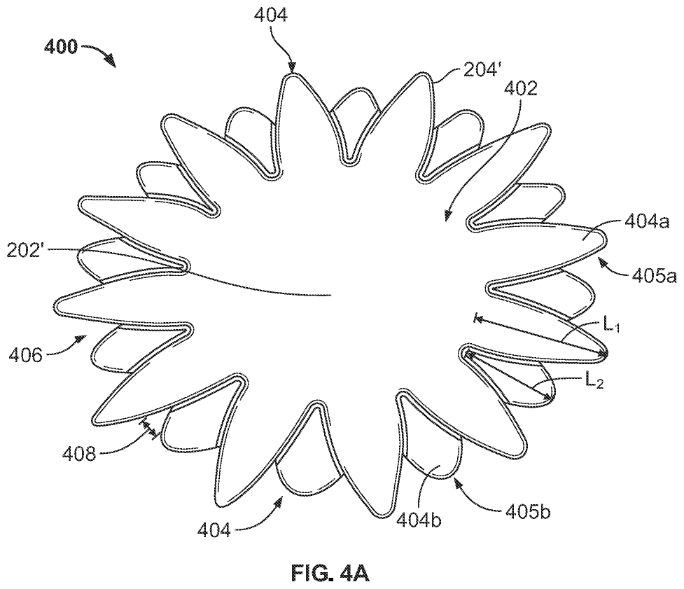

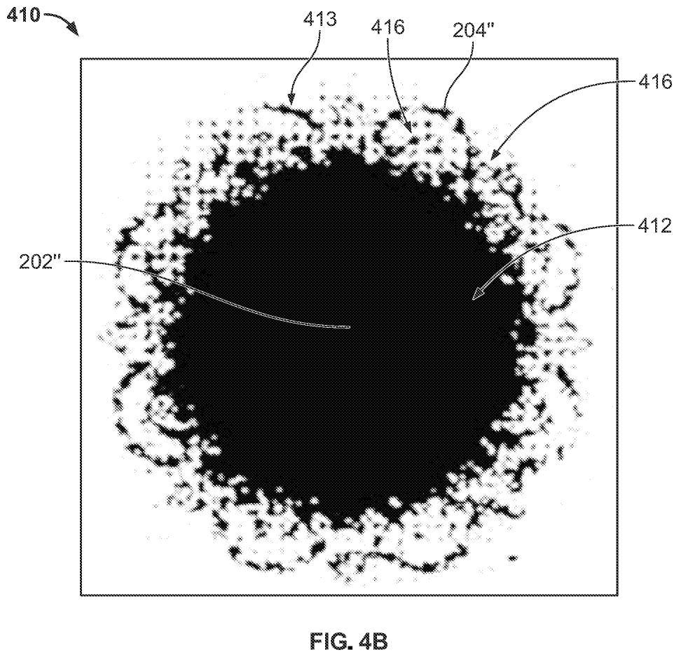

The concealer 110 of the breast cup 105a may include a center 202 and a periphery 204. The center 202 and the periphery 204 of the concealer 110 are illustrated in FIG. 2 as schematic circles. However, the shape of the center 202 and periphery 204 of the concealer 110 may vary. For example, the center 202 may be provided as a first shape that is substantially elliptical, substantially ovular, substantially circular, or substantially polygonal. As an additional example, the periphery 204 of the concealer may be provided as a second shape that is non-circular, an irregular pattern with openings, a pattern including indentations, and/or a pattern including other irregularities. As yet another example, the first shape of the center 202 and the second shape of the periphery 204 may be substantially identical, or the center 202 and the periphery 204 may form a portion of one, larger shape. Example embodiments of the shape of the center 202 and periphery 204 of the concealer 110 are described in more detail with reference to FIGS. 4A and 4B.

In addition, the concealer 110 may have a thickness that varies between a first thickness value at or near a center 202 of the concealer 110 and a second thickness value at or near a periphery 204 of the concealer 110. Preferably, the first thickness value is greater than the second thickness value, although the second thickness value may be greater than the first thickness value. In some embodiments, the center 202 may include a center point such that the center point of the concealer has the first thickness value, and the thickness gradually reduces in a uniform or substantially uniform manner from the center point towards the periphery 204 of the concealer 110.

Referring still to FIG. 2, the thickness of the concealer 110 may taper gradually between the center 202 to the periphery 204. For example, the thickness of the concealer 110 may decrease at a gradual, even, slope from the first thickness value at or near the center 202 to the second thickness value at or near the periphery 204. In some embodiments, the second thickness value is substantially zero, such that the thickness of the concealer 110 reduces to about zero thickness at the outer periphery of the concealer 110. In addition, the first thickness value of the center 202 of the concealer 110 may vary from about 0.02 mm to about 3 mm. For example, the first thickness value of the center 202 of the concealer 110 may be no greater than about 3 mm, or no greater than about 2 mm, or no greater than about 1 mm, or no greater than about 1 mm, or no greater than about 0.5 mm, or no greater than about 0.2 mm. Preferably, the first thickness value of the center 202 of the concealer 110 may be about 0.025 mm to about 2.5 mm.

In some embodiments, the thickness of the concealer 110 may diminish from the first thickness value of about 3 mm (at or near a general center of the concealer 110) to the second thickness value of about 0 mm at the periphery 204. In other embodiments, the first thickness value at, proximate to, or adjacent to the center 202 may be less than about 3 mm, the second thickness value at, proximate to, or adjacent to the periphery 204 may be about 0 mm, and the concealer 110 may taper in thickness between the center 202 and the periphery 204.

The thickness of the concealer 110 may gradually or rapidly decrease from the center 202 (having the first thickness value) to the periphery (having the second thickness value). The reduction in thickness (e.g., the tapering) from the center 202 of the concealer 110 to the periphery 204 may be linear or nonlinear, and the reduction in thickness may be continuous or discontinuous.

The center 202 of the concealer 110 is intended to be positioned at or proximate to an apex of the breast cup 105a, for example, to substantially align with a nipple or areola of a wearer (e.g., the wearer 102 of the brassiere 100) when the brassiere 100 is worn. The size and shape of the center 202 of the concealer 110 may vary relative to the total area and shape of the concealer 110. For example, the center 202 of the concealer 110 of FIG. 2 is a circle with a diameter that is about half of the diameter of the entire concealer 110; thus, the center 202 occupies about one-quarter of the overall area of the concealer 110 with the periphery 204 occupying the remaining portion. However, the diameter of the center 202 and/or the periphery 204 may vary such that the area of coverage provided by the center 202 and the periphery 204 may also vary. For example, the diameter of the center 202 may be increased or decreased from the length illustrated in FIG. 2. In addition, including in embodiments in which the center 202 is not provided in the form of a circle, the center 202 may occupy a different proportion of the overall area of the concealer 110 than illustrated in FIG. 2.

The overall shape of the concealer 110, including the thickness of the concealer 110, may vary. For example, the concealer 110 may be provided in the form of a circle, oval, star, heptagon, hexagon, octagon, a hybrid of these shapes, and/or other shapes. In addition, the concealer 110 may take on several prints or strikes, varying patterns, and/or varying diameters and thicknesses. In some embodiments, the overall shape of the concealer 110 may be modified to have decreasing coverage (e.g., by increasing the number and/or size of voids in the polymer forming the concealer 110, or by decreasing the thickness of the concealer 110) from the center 202 to the periphery 204. For example, the coverage of the concealer may transition from a thicker polymer layer at or near the center of the concealer 110 to a thinner or diminishing layer of the polymer at the periphery of the concealer 110.

The tapering of the thickness of the concealer 110 along with the shape and design of the periphery 204 of the concealer 110 may help to mask the concealer 110 from view when the concealer 110 is assembled onto the breast cup 105a. For example, the periphery 204 may include a non-circular, irregular pattern with indentations, openings, and/or other irregularities that act to hide the periphery of the concealer 110 from view. The irregularities in the periphery 204 of the concealer 110 may be less visible and less noticeable to the naked eye when covered by the second layer of fabric 108 as compared to a periphery design provided with a consistent, continuous peripheral edge. The irregularities may act to blur (e.g., reduce the visibility of) the periphery 204 of the concealer 110 from the naked eye of a viewer, while also contributing to the flexibility of the breast cup 105a.

The polymer of the concealer 110 (and thus the concealer 110 itself) may be applied to the first layer of fabric 106 and/or the second layer of fabric 108 using a variety of apparatuses and methods. For example, the polymer may be applied via screen printing, laser sintering, digital printing, extrusion, injection molding, a combination of these, or other suitable application types. One preferred method of application is screen printing due to the ready availability and knowledge in the market of screen printing processes and equipment. Other preferred methods include digital printing and laser sintering due to reduced labor and material waste associated with the processes. Regardless of the apparatus used, the same general principles may apply regarding how the polymer is coupled to the fabric layers. For example, the polymer may be applied to the outer surface 304 of the first layer of fabric 106, and the polymer may couple to the first layer of fabric 106 upon curing of the polymer. Alternatively, or in addition, the polymer may be applied to the inner surface 306 of the second layer of fabric 108, and the polymer may couple to the second layer of fabric 108 upon curing of the polymer. Curing the polymer may include heating the polymer, exposing the polymer to ultraviolet light or other curing frequencies, combining the polymer with a catalyst, and/or other suitable curing methods. Curing the polymer may couple or adhere the polymer to the fabric material (e.g., the first layer of fabric 106 and/or the second layer of fabric 108) and may maintain the thickness properties of the concealer 110 (i.e., that the thickness of the concealer 110 varies from the center 202 of the concealer 110 to the periphery 204).

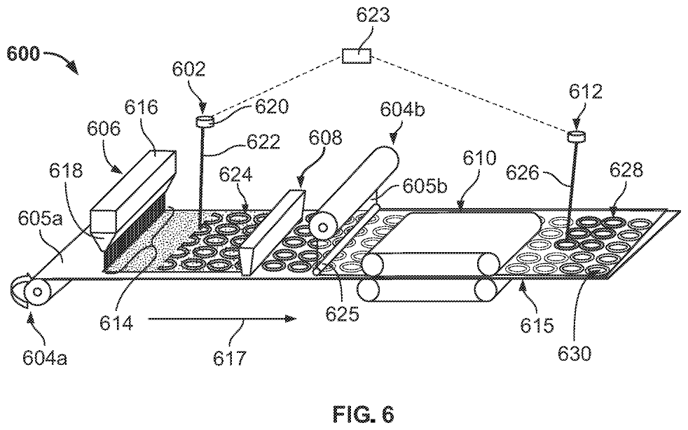

In some embodiments, as described in more detail with reference to FIGS. 6-8, the concealer 110 may be produced via any of the laser sintering apparatuses 600, 700, 800 and using any of the polymers 614, 714, and/or 814. In particular, the concealer 110 may be laser sintered onto the first layer of fabric 106 and/or the second layer of fabric 108 using a sintering laser 602, 702, or 802 to produce the brassiere 100. Further, the sintering laser 602, 702, 802 may be controlled such that the predetermined pattern produced in sintered polymers 624, 724, or 824 includes the varying thicknesses, shapes, and patterns of the concealer 110, as described herein.

The polymer comprising the concealer 110 may take a variety of forms. For example, the polymer may include urethane, polyurethane, silicone, plastisol, or a combination of these materials. In some instances, the polymer is a water-based polymer that is urethane-based, such as polyurethane. In some examples, the polymer is provided as a thermoplastic elastomer (“TPE”), such as a TPE that includes polyurethane. Preferred polymers may include, but are not limited to urethanes, silicones, and/or thermoplastic elastomers. These polymers may be preferred due to, for example, the ease of processing these polymers, the flexibility of the polymers, and/or the comfort these polymers provided to the wearer 102 when the brassiere 100 is worn.

A first example concealer 400 and a second example concealer 410 are provided in FIGS. 4A and 4B, respectively. Each of the first and second example concealers 400, 410 may be used as the concealer 110 in the breast cup 105a of FIGS. 2 and 3 and the brassiere 100 of FIG. 1. Although the shape of the first and second example concealers 400, 410 will be described in detail herein, the general teachings related to the shape of the example concealers 400, 410 may apply to any concealer provided with the brassiere 100. In addition, similarly named and numbered parts of the concealers 110, 400, 410 may have substantially the same structure and function.

The first example concealer 400 of FIG. 4A is an example representation of an injection molded polymer, and the second example concealer 410 of FIG. 4B is a polymer designed to be printed (e.g., screen printed) onto a layer of fabric. However, other means of creating concealers (e.g., screen printing, digital printing, laser sintering, injection molding, or extrusion) may be utilized while still acquiring the same or similar shape for the first example concealer 400 and the second example concealer 410.

The first example concealer 400 may be provided in the form of a body 402 having a substantially sunburst shape. More specifically, the first example concealer 400 may include a center area 202′ having a substantially circular shape and a plurality of cone-shaped protrusions or rays 404 extending radially outward from the center area 202′. The rays 404 may taper (i.e., reduce in thickness and/or width) from the center area 202′ to a periphery 204′. The shape of the plurality of rays 404 may provide the periphery 204′ in a substantially non-circular, irregular shape that includes a plurality of indentations and/or irregular changes in shape. The plurality of indentations and irregular changes in shape may, for example, help mask the periphery 204′ of the first example concealer 400 from view when the first example concealer 400 is covered by a fabric layer (e.g., the second layer of fabric 108) and viewed from the exterior.

In some embodiments, the rays 404 may be provided in the form of a plurality of first rays 404a and a plurality of second rays 404b. The first and second plurality of rays 404a, 404b may be provided as protrusions that are substantially a same length, or the first and second plurality of rays 404a, 404b may be provided as protrusions having different lengths. For example, as illustrated in FIG. 4A, the plurality of first rays 404a may have a first length L₁ that is greater than a second length L2 of the plurality of second rays 404b. Further, each of the first and second plurality of rays 404a, 404b may have an end (illustrated as ends 405a and 405b, respectively) provided as different shapes or as substantially the same shape. For example, as illustrated in FIG. 4A, the ends 405a may be somewhat narrower than the ends 405b.

The tapering of the thicknesses of the first and second plurality of rays 404a, 404b may be the same, or the degree of tapering may be different. For example, the thickness of the plurality of first rays 404a may decrease from the center area 202′ towards the periphery 204′ at a first rate that is greater than, less than, or substantially the same as a second rate by which the plurality of second rays 404b taper. Alternatively, the thickness of the plurality of second rays 404b may decrease from the center area 202′ towards the periphery 204′ at a second rate that is greater than, less than, or substantially the same as a first rate by which the plurality of first rays 404a taper. Furthermore, as described with reference to the concealer 110, the rate at which the body 402 (and thus the rays 404, 404b) tapers may be continuous, discontinuous, constant, and/or variable. As such, the tapering at the first rate and the second rate may also be continuous, discontinuous, constant, and/or variable.

The tapering of the widths of the first and second plurality of rays 404a, 404b may be the same, or the degree of tapering may be different. For example, the widths of the plurality of first rays 404a may decrease from the center area 202′ towards the periphery 204′ at a third rate that is greater than, less than, or substantially the same as a fourth rate by which the plurality of second rays 404b taper. Alternatively, the widths of the plurality of second rays 404b may decrease from the center area 202′ towards the periphery 204′ at a fourth rate that is greater than, less than, or substantially the same as a third rate by which the plurality of first rays 404a taper. Furthermore, the rate at which the widths of the first and second plurality of rays 404a, 404b taper may be continuous, discontinuous, constant, and/or variable. As such, the tapering at the third rate and the fourth rate may also be continuous, discontinuous, constant, and/or variable.

The arrangement, tapering and/or the lengths of the first and second plurality of rays 404a, 404b may create voids 406 in the first example concealer 400. Generally, the voids 406 may be locations or areas within or proximate to the body 402 in which little or substantially no polymer is present. As illustrated in FIG. 4A, the voids 406 are provided as gaps 408 positioned and located between each of the first rays 404a and the second rays 404b. In alternative embodiments, the voids 406 may be positioned elsewhere on or proximate to the body 402 (e.g., proximate or adjacent to the center area 202′). In other embodiments, the body 402 may not include voids 406.

Turning to FIG. 4B, the second example concealer 410 may be provided in the form of a body 412 having a splatter-type shape or pattern. The body 412 includes a substantially circular or oval-shaped center area 202″ and a periphery 204″ having a broken peripheral pattern. The thickness of the body 412 may taper from the center area 202″ to an outer edge 413 of the periphery 204″. The periphery 204″ may be substantially non-circular and include broken patterns of irregular shapes and openings to, for example, better mask the periphery 204″ of the second example concealer 410 from view when covered by a fabric layer (e.g., the second layer of fabric 108) and viewed from the exterior.

The splatter-type shape of the body 412 may include voids 416 in which little or substantially no polymer is present. In some embodiments, the voids 416 may be created in locations wherein little or substantially no polymer is deposited on a layer of fabric before the polymer is cured. In other embodiments, the voids 416 may be created in locations of the body 412 wherein the polymer is not coupled to a layer of fabric. The density of the voids 416 throughout the body 412 may be constant, or the density of the voids 416 may vary throughout the body 412 (either in a continuous or discontinuous manner). For example, as illustrated in FIG. 4B, the density of the voids 416 in the second example concealer 410 is greater near the periphery 204″ than near the center area 202″. However, in alternative embodiments, the second example concealer 410 may be provided in a form in which the density of the voids 416 increases towards the center area 202″ (as compared to the periphery 204″) of the body 412, or the density of the voids 416 may be substantially constant throughout the body 412. In yet other embodiments, the second example concealer 410 may be provided in a form that does not include the voids 416.

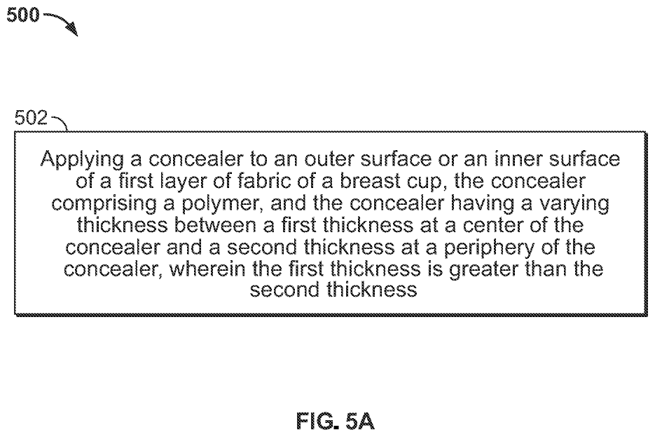

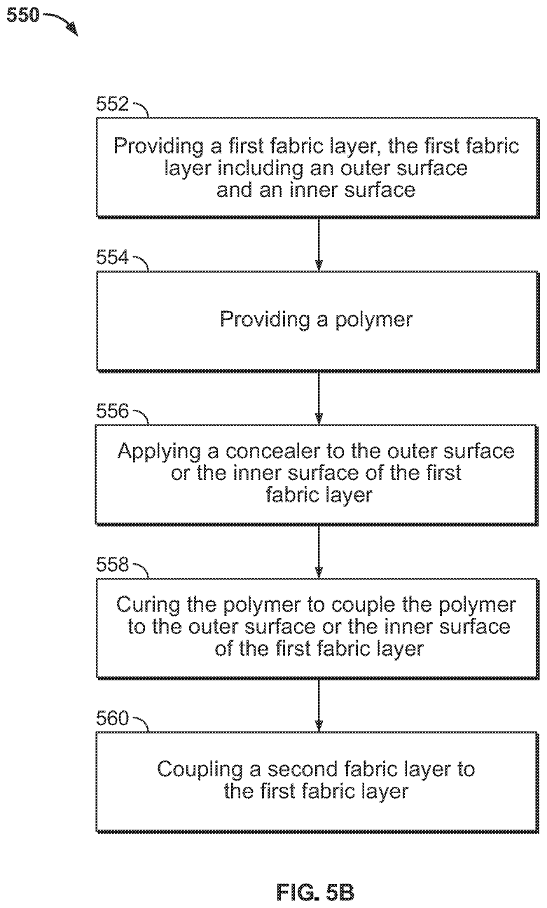

Turning next to FIG. 5A, a method 500 for forming a breast cup of a brassiere is provided. In some instances, the method 500 may be used to create the breast cup 105a or 105b of the brassiere 100. The method 500 may include a step 502 of applying a concealer to an outer surface or an inner surface of a first layer of fabric of a breast cup. The concealer may include a polymer and may have a thickness that varies between a first thickness value at a center of the concealer and a second thickness value at a periphery of the concealer. For example, the first thickness value may be greater than the second thickness value. In some instances, the thickness gradually decreases or tapers from the first thickness value at a center of the concealer to the second thickness value at a periphery of the concealer.

In some embodiments, applying the polymer of the concealer may include a step of screen printing the polymer, laser sintering the polymer, or extruding the polymer of the concealer to the outer surface of the first layer of fabric. The polymer may be provided in the form of urethane, polyurethane, silicone, and/or plastisol. In some embodiments, the polymer is a water-based polymer that is urethane-based. For example, the polymer may include a thermoplastic elastomer, such as polyurethane. In other embodiments, the polymer may include silicone, and the method may include a step of adding a catalyst to the silicone before applying the polymer of the concealer to the outer surface of the first layer of fabric.

Applying the concealer to the outer surface of the first layer of fabric, as described in the method 500, may include gradually varying the thickness of the concealer from the center of the concealer to the periphery of the concealer. In some embodiments, the first thickness value is less than about 3 mm, or less than about 2 mm, or less than about 1 mm, or less than about 0.5 mm, or less than about 0.1 mm, or less than about 0.05 mm, or less than about 0.02 mm. In other embodiments, the second thickness value is about zero millimeters, such that the thickness of the concealer reduces to about zero thickness at its outer periphery.

In some embodiments of the method 500, the polymer of the concealer may be applied directly to the outer surface of the first layer of fabric. In other embodiments, a second layer of fabric may be coupled to an outer side of the first layer of fabric (e.g., via stitching, bonding, or an adhesive) such that the first layer of fabric and the second layer of fabric surround the concealer. In some such embodiments, the concealer is attached to an inner surface of the second layer of fabric.

As illustrated in FIG. 5B, a method 550 of forming a breast cup for a brassiere is provided. The method 550 may comprise a step 552 of providing a first fabric layer, the first fabric layer including an outer surface and an inner surface. The method 550 may further comprise a step 554 of providing a polymer. The method 550 may also comprise a step 556 of applying a concealer to the outer surface or the inner surface of the first fabric layer. The method 550 may further comprise a step 558 of curing the polymer to couple the polymer to the outer surface or the inner surface of the first fabric layer. Optionally, the method may comprise a step 560 of coupling a second fabric layer to the first fabric layer. In some embodiments of the step 560, the first and second fabric layers may substantially surround the concealer.

In some embodiments of the method 550, the polymer applied to the first fabric layer in the step 556 may have a varying thickness. In other embodiments, after the polymer is applied to the first fabric layer in the step 554 and/or after the polymer is cured in the step 558, the polymer may have a first thickness value near a center portion of the polymer and a second thickness value near a periphery of the polymer. In such embodiments, the polymer may taper from the center to the periphery. In some embodiments, the first thickness value is less than about 3 mm, or less than about 2 mm, or less than about 1 mm, or less than about 0.5 mm, or less than about 0.1 mm, or less than about 0.05 mm, or less than about 0.02 mm. In other embodiments, the second thickness value is about zero millimeters.

In some embodiments of the method 550, the method further comprises providing a center portion of the concealer in a first pattern and a periphery of the concealer in a second pattern, wherein the first pattern is substantially elliptical, substantially ovular, or substantially circular, and wherein the second pattern is substantially irregular.

In other embodiments, the method 550 may comprise a step of providing a laser sintering apparatus including a polymer coater and a sintering laser, the polymer coater adapted to retain the polymer until the polymer is applied to the first fabric layer. In such embodiments, the step of providing the polymer is carried out by the polymer coater, and the polymer is cured when a laser of the sintering laser strikes the polymer.

FIG. 6 illustrates an embodiment of the garment manufacturing apparatus 600 designed to utilize the sintering laser 602 in the production of a fabric and/or a garment that includes a polymer. The type of garment that can be produced using the apparatus 600 is not particularly limited and may include bras, underwear, shapewear, leggings, athletic clothing, swimwear, t-shirts, sweatshirts, hooded sweatshirts, face masks, gloves, and shoe soles. For example, the apparatus 600 may produce a garment including a polymer 614 coupled thereto (e.g., the brassiere 100 and the bra cups 105a, 105b illustrated in FIGS. 1-3). The apparatus 600 may include at least one fabric roll 604, a polymer coater 606, a vacuum apparatus 608, a press 610, and/or a cutting apparatus 612.

Referring still to FIG. 6, at least one fabric roll 604 may be provided with or coupled to the apparatus 600. For example, in one embodiment, two fabric rolls 604a, 604b (e.g., a first fabric roll 604a and a second fabric roll 604b) may be provided. The at least one fabric roll 604 may be provided in the form of an elongated cylinder and may include a bearing and/or other components that allow the rolls 604 to rotate. A fabric 605 may be wrapped around a center portion or a spool of the fabric roll 604, and the fabric 605 can be unspooled off the fabric roll 604 as the apparatus 600 is in use. The fabric 605 provided on the at least one fabric roll 604 may include at least one natural fabric, synthetic fabric, and combinations thereof. Non-limiting examples of natural fabrics include cotton, hemp, linen, bamboo, ramie, silk, and wool fabrics. Non-limiting examples of synthetic fabrics include rayon, nylon, spandex, polyester, olefin, polyvinyl chloride, and acrylic fabrics. In some embodiments, the fabric 605 may be provided as the first layer of fabric 106 and/or the second layer of fabric 108 in the brassiere 100 or breast cup 105a of FIGS. 1-3.

In the example depicted, two fabric rolls 604a, 604b are provided. The fabrics 605a, 605b provided on the fabric rolls 604a, 604b may be the same, or the fabrics 605a, 605b may be different. For example, the fabric 605a may comprise a natural fabric and the fabric 605b may comprise a synthetic fabric. As an additional example, the fabric 605a may be provided as a soft-touch fabric (e.g., a non-abrasive or a low-friction fabric) and the fabric 605b may be provided as a substantially waterproof fabric.

By way of example, the apparatus 600 may produce a single-layer fabric, a multi-layer fabric, a single-layer garment, or a multi-layer garment. Further, if a multi-layered fabric or garment is produced, the fabric and/or garment may have different properties on a wearer-facing layer (e.g., the wearer-facing layer may be a soft-touch layer) and an outer-facing layer (e.g., the outer-facing layer may be a waterproof layer). For example, with reference to FIGS. 1-3, the apparatus 600 may produce a first layer of fabric 106 with a concealer (e.g., the concealer 110) coupled thereto.

Referring again to FIG. 6, the apparatus 600 may include a belt 615 provided in the form of an elongated, substantially planar surface. The belt 615 may be positioned adjacent to the first fabric roll 604a and may extend in the direction indicated by an arrow 617 until the belt 615 is proximate to the cutting apparatus 612. In some embodiments, the belt 615 may extend in the direction indicated by the arrow 617 beyond the cutting apparatus 612. The fabrics 605a, 605b may be positioned on or proximate to the belt 615 and be moved by the belt 615 through the apparatus 600 in the direction indicated by the arrow 617. For example, the belt 615 may move the fabric 605a away from the fabric roll 604a and in the direction indicated by the arrow 617 such that the fabric 605a can be provided to the polymer coater 606 and the sintering laser 602. As an additional example, after the fabric 605b is positioned adjacent to the belt 615, the belt 615 may move the fabrics 605a, 605b in the direction indicated by the arrow 617 until the fabrics 605a, 605b are provided to the cutting apparatus 612.

If more than one fabric roll 604 is provided, the polymer 614 may be provided to at least one of the fabrics 605a, 605b. The polymer 614 is provided to the fabric 605a by the polymer coater 606. The polymer coater 606 may be provided in the form of a body 616 coupled to a dispensing mechanism 618. The body 616 may retain the polymer 614 until the polymer 614 is provided to the fabric 605a by the dispensing mechanism 618. The form of the dispensing mechanism 618 is not particularly limited. For example, the dispensing mechanism 618 may include apertures (not illustrated) that can allow the polymer 614 to fall from the dispensing mechanism 618 and onto the fabric 605a via the action of gravity. In such embodiments, the size of the apertures of the dispensing mechanism 618 may be adjusted to control the amount of polymer 614 that is provided to the fabric 605a. In other embodiments, the dispensing mechanism 618 and/or polymer coater 606 may be provided as a roller, doctor blade, or spray mechanism. Other similar dispensing mechanisms would be appreciated by those skilled in the art.

The polymer 614 may be provided to the fabric 605a in the form of a solid, liquid, or gel. For example, the polymer 614 may be provided as a powder, a film, particulates of various sizes, pellets, or combinations thereof. Preferably, the polymer 614 is provided to the fabric 605a in the form of a powder or pellet.

In some embodiments, the polymer 614 may comprise any polymer that can be ground into or provided as a small particulate. For example, if the polymer 614 is provided as substantially spherical particles, the polymer 614 may be provided as particles measuring no more than about 3 mm along the particles' diameter. As an additional example, the average size of the polymer 614 particles supplied to the fabric 605a may be no greater than about 4 mm, or no greater than about 3 mm, or no greater than about 2 mm, or no greater than about 1 mm, or no greater than about 900 μm, or no greater than about 500 μm, or no greater than about 100 μm, or no greater than about 50 μm, or no greater than about 10 μm, or no greater than about 5 μm. For example, the average size of the polymer 614 particles provided to the fabric 605a may be about 100 μm to about 5 μm. Preferably, the polymer 614 is provided in the form of particles that are sufficiently small to fuse to the fabric substrate if a laser strikes only a portion of the particle.

The polymer 614 may comprise a single polymer or may be a mixture containing at least one polymer. For example, the polymer 614 may be provided as a urethane polymer, a polyurethane polymer, a silicone polymer, a plastisol polymer, or a combination of the foregoing. As an additional example, the polymer 614 may be provided as a water-based polymer that is urethane-based. As a further example, the polymer may comprise a thermoplastic elastomer, e.g., polyurethane.

In some embodiments, the polymer 614 may be mixed or provided with additives before, during, or after the polymer 614 is applied to the fabric 605a. Such additives may improve the processability of the polymer 614 (e.g., by increasing the energy absorbed by the polymer 614 when the polymer 614 is laser sintered). For example, the additives may comprise infrared absorbing dyes and/or talc (Mg₃Si₄O₁₀(OH)₂). As an additional example, the polymer 614 may comprise silicone and the additive may comprise a catalyst which is added to the silicone before applying the polymer 614 to the fabric 605a.

In some embodiments, the fabric 605a and/or the fabric 605b may be treated before being provided to the apparatus 600. For example, the treatment may alter the properties of the fabrics 605a, 605b to increase their water resistance, air permeability, stain resistance, ability to adhere to the polymer 614, and the like. Preferably, the treatment increases the ability of the fabric 605a to adhere to the polymer 614. For example, the fabric 605a may be ionized to improve the adhesion of the polymer 614 to the fabric 605a. Without being bound to a particular theory, it is believed that ionization increases the intermolecular forces between the fabric 605a and the polymer 614, which may increase the adhesion of the fabric 605a to the polymer 614. Alternatively, another treatment process, such as applying a secondary polymer to the fabric to increase the adhesion of the fabric 605a to the polymer 614, could be used. In other embodiments, the treatment described herein could occur after the fabrics 605a, 605b are provided to the apparatus 600.

Still referring to FIG. 6, after the polymer 614 is applied to the fabric 605a, the polymer 614 may be laser sintered using the sintering laser 602. Optionally, the polymer 614 is leveled (e.g., via a roller, press, or other leveling device, not illustrated), on the fabric 605a prior to the sintering to create a substantially flat and/or level powder material layer on the surface of the fabric 605a. Leveling the polymer 614 may increase the efficiency and/or precision of the laser sintering process. Additionally, the leveling process may result in the polymer 614 having a first thickness value and a second thickness value, such as the first and second thickness values described with reference to FIGS. 2 and 3. If provided, the roller may be positioned between the polymer coater 606 and the sintering laser 602.

Referring again to FIG. 6, the sintering laser 602 may be provided in the form of a laser body 620 within which a laser 622 is generated. The laser body 620 may generate the laser 622 via known methods. The laser 622 may have a wavelength within the infrared, visible light, or ultraviolet range. For example, the laser 622 may be any infrared laser having a wavelength between about 700 nm and about 20,000 nm. In addition, the laser 622 may be utilized during the sintering process at a variety of power levels, such power levels within the range of about 0% power and about 100% power. Suitable lasers for generating wavelengths in the infrared spectrum include, but are not limited to, solid-state fiber lasers and CO₂ lasers. In one embodiment, the laser 622 may be provided as a 60 W CO₂ laser that operates at about 30% power when sintering the polymer 614. Alternatively, a fiber laser (i.e., a laser containing an optical fiber doped with rare-earth elements) may be provided as the sintering laser 602. Typically, the energy from the sintering laser 602 is provided in a binary fashion, in that the laser either (1) applies energy to the polymer 614 at a sufficient level to sinter the polymer 614 or (2) does not apply energy to the polymer 614.

In some embodiments, the apparatus 600 may include more than one sintering laser 602. In such embodiments, the sintering lasers 602 may emit a laser 622 with the same wavelength, or the sintering lasers 602 may emit lasers 622 with different wavelengths. If more than one sintering laser 602 is provided, a single garment or fabric may be produced by the sintering lasers 602, or multiple garments or fabrics may be produced by the sintering lasers 602. Preferably, only one sintering laser 602 is used when creating any individual garment and/or fabric.

The sintering laser 602 may be provided on a structure or an apparatus (not illustrated) that is designed to allow the sintering laser 602 to traverse a first X-Y plane provided over the fabric 605a. For example, the sintering laser 602 may be provided on a gantry system or galvo system such that the laser 622 may be focused on particular locations of a second X-Y plane defined by a top surface of the fabric 605a. Thus, as the fabric 605a moves past the location where the sintering laser 602 is provided, the sintering laser 602 may sinter the polymer 614 in a predetermined pattern. In some embodiments, a controller 623 may control the movement and/or the power output of the sintering laser 602 such that the predetermined pattern may be formed.

Referring still to FIG. 6, the sintering laser 602 may be coupled to or in electrical communication with the controller 623. The controller 623 may be provided in the form of a computer system having one or more of a processor, a memory, and a drive unit with a machine-readable medium that includes software designed to store and execute modules, methodologies, and/or functions described herein. For example, the controller may include software adapted to control the motion of the sintering laser 602 such that the sintering laser 602 can create a sintered polymer 624 provided in the form of a predetermined pattern or shapes. The predetermined pattern is not particularly limited and may include a lattice design, a striped design, a chevron design, geometric designs, and/or other functional and artistic patterns that would be appreciated by those skilled in the art. In addition, the predetermined pattern may include any of the designs taught with reference to the concealers 110, 400, and 410 of FIGS. 2, 3, 4A, and 4B.

Generally, the predetermined pattern of the sintered polymer 624, and the amount of polymer 614 that is used to create the sintered polymer 624, may contribute to the form and function of the fabric. For example, the sintered polymer 624 may provide: structural support; a fabric and/or garment with at least one textured or tacky surface; a decorative element; a surface upon which portions of the fabric and/or garment may bond; increased rigidity in at least a portion of a garment (e.g., a breast cup); elements which may help conceal characteristics of a person wearing the garment (e.g., the areola of the person); and/or other desired features. For example, the sintered polymer 624 may be provided in a form of the concealer 110 (as illustrated in FIGS. 2 and 3), the first example concealer 400 (see FIG. 4A) or the second concealer 410 (see FIG. 4B). As an additional example, by sintering the polymer 614 to the fabric 605, a garment manufacturer may create a bonding fabric adapted to replace seams within a garment, or a seamless garment.

In some embodiments, the polymer 614 may not be applied to the fabric 605a directly. Instead, the polymer 614 may be applied to a carrier material, sintered on the carrier material, and then transferred to the fabric 605a. For example, the concealer 110 illustrated in FIGS. 2 and 3 may be provided on a carrier material before being coupled to the brassiere 100 or the breast cups 105a, 105b (see FIGS. 1-3).

Referring again to FIG. 6, during and/or after sintering, the polymer 614 may intercalate into the fabric 605a such that the polymer 614 physically bonds to the fabric 605a. This intercalation or “curing” process may adhere the polymer 614 to the fabric 605a in the predetermined pattern, creating the sintered polymer 624. In some embodiments, the predetermined pattern of the sintered polymer 624 may be created, but the polymer 614 may not intercalate with the fabric 605a. In such embodiments, a laminating or bonding apparatus may be provided that may adhere the sintered polymer 624 to the fabric 605a via the application of heat, pressure, UV light, laser power, other electromagnetic means, or a combination thereof. Alternatively, the sintered polymer 624 may not be coupled to the fabric by the apparatus 600 and can be coupled to another fabric or garment at a later time.

After sintering, any unsintered polymer 614 may be removed from the fabric 605a. For example, the unsintered polymer 614 may be removed by the vacuum apparatus 608. The vacuum apparatus 608 may be adapted to remove unsintered polymer 614 from the surface of the fabric 605a without substantially disturbing or damaging the sintered polymer 624. The vacuum apparatus 608 may create a pressure differential above the surface of the fabric 605a such that the unsintered polymer 614 is removed from the fabric 605a. As an additional example, the vacuum apparatus 608 may be provided as a vacuum and an air blade (not illustrated). If the air blade is provided, the air blade may be positioned adjacent to the vacuum to assist the vacuum in capturing any unsintered polymer 614. Optionally, the unsintered polymer 614 can be recycled to the polymer coater 606 to reduce the amount of polymer waste generated by the apparatus 600. This may be particularly beneficial for the garment manufacturers, since the polymer 614 provided to the fabric represents a significant portion of the cost of manufacturing the fabric or garment produced by the apparatus 600.

Optionally, the fabric roll 604b including a fabric 605b may be provided after the vacuum apparatus 608. As stated above, the fabric 605a may be the same as, or different than, the fabric 605b. If the fabric roll 604b is provided, a two-ply fabric or a two-ply garment may be produced by the apparatus 600.

Referring still to FIG. 6, a roller 625 may be provided that guides the fabric 605b from the fabric roll 604b and positions the fabric 605b such that the fabric 605b is adjacent to the fabric 605a and/or the belt 615. The roller 625 may be provided in the form of an elongated cylinder that extends at least a width of the fabrics 605a, 605b. The roller 625 may help ensure that the fabric 605b is applied to the fabric 605a in a substantially smooth configuration (e.g., a configuration that is substantially free of wrinkles). By applying the fabric 605b to the fabric 605a in a substantially smooth configuration, the apparatus 600 can produce a fabric or garment that does not have a surface that is “bunched up” or wrinkled after the production process.

Optionally, the fabric 605b may also bind to the sintered polymer 624. In some embodiments, the roller 625 may bind the fabric 605b to the sintered polymer 624 via the application of a force or energy that intercalates the sintered polymer 624 into the fabric 605b. For example, the roller 625 may be heated such that, as the fabrics 605a, 605b pass under the roller 625, the sintered polymer 624 melts sufficiently to allow the sintered polymer 624 to intercalate into the fabric 605b as the fabric 605b is pressed onto the sintered polymer 624. Alternatively, or additionally, the apparatus 600 may include a press 610 that is adapted to facilitate the binding of the sintered polymer 624 and the fabric 605b. The press 610 may be provided in the form of an electric press, a belt press, a hydraulic press, a servo-press, a compression press, a heat transfer press, and the like. Generally, the press 610 may be adapted to apply pressure and/or heat to the fabrics 605a, 605b and/or the sintered polymer 624. Thus, via the application of the pressure and/or heat from the press 610, sufficient energy is transferred to the sintered polymer 624 such that the sintered polymer 624 intercalates with the fabric 605b. Preferably, the press 610 is provided as a heated belt press.

If both fabrics 605a, 605b are coupled to the sintered polymer 624, then the fabrics 605a, 605b may be coupled together without the use of a thread. Thus, a seamless fabric or garment may be produced by the apparatus 600.

Referring again to FIG. 6, the apparatus 600 may be provided with a cutting apparatus 612. The cutting apparatus 612 may, for example, be provided in the form of shears, a rotary cutter, a cutting laser, and the like. Preferably, the cutting apparatus 612 is provided in the form of a cutting laser, such as a cutting laser 626. The cutting apparatus 612, like the sintering laser 602, may be provided on a gantry system or a galvo system such that predefined shapes can be cut from the fabric moving past the cutting laser 626 on the apparatus 600. Further, like the sintering laser 602, the cutting apparatus 612 may be coupled to or in electrical communication with the controller 623. The controller 623 may control the motion of the cutting apparatus 612 such that the predefined shapes can be cut out of the fabrics 605a, 605b. In addition, the cutting laser 626 may be provided as any of the lasers recited above with respect to the laser 622. For example, the cutting laser 626 may be provided as a 60 W CO₂ laser operating at about 20% power during the cutting process.

In some embodiments, such as the embodiment illustrated in FIG. 6, the sintering laser 602 and the cutting apparatus 612 may be controlled by the same controller (e.g., the controller 623). In other embodiments, the sintering laser 602 and the cutting apparatus 612 may be in communication with separate controllers (not illustrated).

A finished textile 628 may be produced by the cutting apparatus 612. In some embodiments, the finished textile 628 may be a finished fabric (i.e., a fabric that needs substantially no further processing or minimal further processing before being used in the creation of a garment, such as the first layer of fabric 106 and/or the second layer of fabric 108 of FIGS. 1-3), or the finished textile 628 may be a finished garment (i.e., a garment that is ready to wear with substantially no further processing or minimal further processing, such as the brassiere 100 of FIG. 1). In addition, after the finished textile 628 is removed from the fabrics 605a, 605b, a cut portion 630 may be provided in the fabrics 605a, 605b. In some embodiments, the cut portion 630 may be utilized to produce a finished fabric or a finished garment, or the cut portion 630 may be recycled or otherwise disposed of. Either the finished textile 628 or the cut portions 630 may include the sintered polymer 624, as desired by the garment manufacturer.

Preferably, the finished textile 628 is provided as a finished fabric including the sintered polymer 624 or a finished garment including the sintered polymer 624. For example, the finished textile 628 may be a finished fabric that is designed to be thermally pressed into a liner fabric of a garment. As an additional example, the finished textile 628 may be a finished fabric that is designed to be stitched to another fabric or a liner to produce a garment. As yet another example, the finished textile 628 may be provided as a seamless, finished garment.

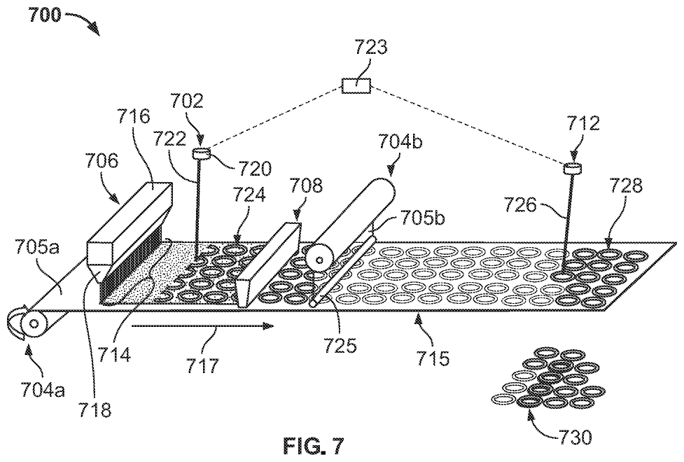

Turning to FIG. 7, an apparatus 700 for producing a fabric and/or a garment that includes a polymer is illustrated. The apparatus 700 may have a substantially similar function and operation as the apparatus 600. In addition, the embodiment of FIG. 7 may include a sintering laser 702, at least one fabric roll 704 (e.g., fabric rolls 704a, 704b), fabrics 705a, 705b, a polymer coater 706, a vacuum apparatus 708, a belt 715, a roller 725 and/or a cutting apparatus 712 (e.g., a cutting laser 726) having substantially the same function and configuration as the similarly named components described with reference to FIG. 6. Further, like the apparatus 600, the apparatus 700 may produce a one-ply or a two-ply fabric or garment including a sintered polymer 724 (e.g., a finished textile or a cut portion 730). Unlike the apparatus 600, the illustrated embodiment of the apparatus 700 does not include or use a press to produce the finished textile 728.

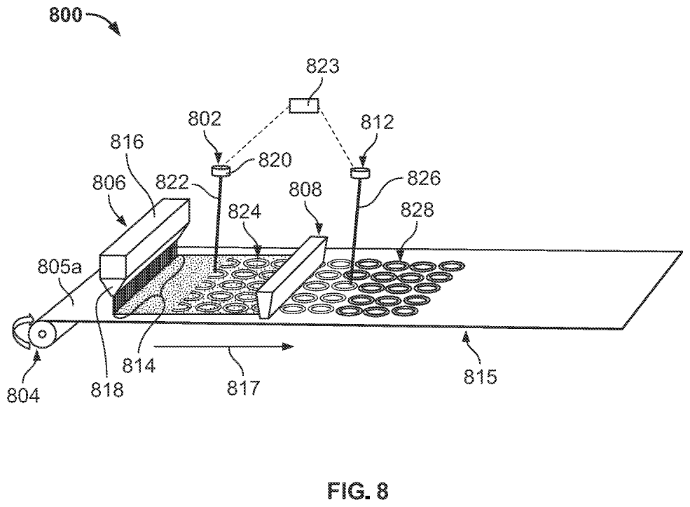

Turning next to FIG. 8, an apparatus 800 for producing a fabric and/or a garment that includes a polymer is illustrated. The apparatus 800 may have a substantially similar function and operation as the apparatuses 600, 700. In addition, the embodiment of FIG. 8 may include a sintering laser 802, a fabric roll 804, a fabric 805a, a polymer coater 806, a vacuum apparatus 808, a cutting apparatus 812 (e.g., a cutting laser 826), and/or a belt 815 having substantially the same function and configuration as the similarly named components described with reference to FIGS. 6 and 7. Generally, the teachings related to the apparatuses 600, 700 described herein may also apply to the apparatus 800. Further, like the apparatuses 600, 700 the apparatus 800 may produce a fabric or garment including a sintered polymer 824 (e.g., a finished textile 828 or a cut portion 830 (not illustrated)). Unlike the apparatuses 600, 700, the illustrated embodiment of the apparatus 800 includes a single fabric roll (i.e., the fabric roll 804). Thus, the apparatus 800 may be configured to produce the finished textile 828 provided in the form of a single-layered finished fabric or a single-layered finished garment. Alternatively, if the fabric 805a is provided as a multi-layered fabric, the apparatus 800 may be configured to produce the finished textile 828 provided in the form of a multi-layered finished fabric or a multi-layered finished garment, wherein the sintered polymer 824 is positioned on an outer surface of the finished textile 828.

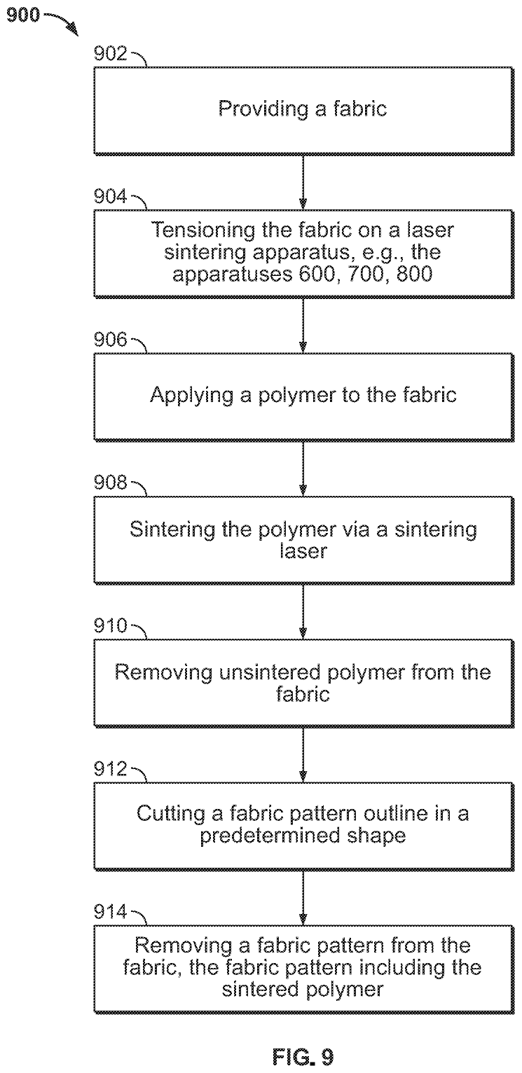

As illustrated in FIG. 9, a method 900 of sintering a polymer to a fabric or a garment is provided. The method 900 may comprise a step 902 of providing a fabric and a step 904 of tensioning the fabric on a laser sintering apparatus, e.g., the apparatuses 600, 700, or 800. The method may further comprise a step 906 of providing or applying a polymer to the fabric. In some embodiments, the polymer may be provided to the fabric as a thin film of powder. The method may also comprise a step 908 of sintering the polymer via a sintering laser. In some embodiments, a laser of the sintering laser may be provided as a carbon dioxide laser. Optionally, the laser may be provided with a wavelength of about 10,000 nm. Optionally, the laser may be provided on a gantry such that the sintering laser can traverse an X-Y plane. The method may further comprise a step 910 of removing unsintered polymer from the fabric. In some embodiments, the unsintered polymer may be removed by a vacuum apparatus. The method may also comprise a step 912 of cutting a fabric pattern outline in a predetermined shape. Optionally, the step 912 may include cutting the fabric pattern with a vacuum apparatus activated. The method may additionally comprise a step 914 of removing a fabric pattern from the fabric, the fabric pattern including the sintered polymer. In some embodiments, the fabric pattern may be provided in the form of a finished garment, such as the brassiere 100 or the bra cup 105a. Optionally, the method may also comprise the step of adhering a face of the fabric pattern to a liner or otherwise coupling the fabric pattern to another fabric or to a garment.

The method 900 may further comprise additional steps consistent with the teachings disclosed herein. In addition, the method 900 may comprise fewer steps than those described herein.

It will be appreciated by those skilled in the art that while the above disclosure has been described above in connection with particular embodiments and examples, the above disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference as if each such patent or publication were individually incorporated by reference herein. Various features and advantages of the above disclosure are set forth in the following claims.

1. A brassiere comprising:
a body portion configured to at least partially encircle a torso of a wearer of the brassiere, the body portion coupled to a pair of breast cups;
the pair of breast cups comprising a first breast cup and a second breast cup, the pair of breast cups configured to support breasts of the wearer, each of the first breast cup and the second breast cup comprising:
a first layer of fabric; and
a concealer coupled to the first layer of fabric, the concealer comprising a polymer including a body having a first thickness value at or proximate to a center of the body and a second thickness value at or proximate to a periphery of the body, wherein the first thickness value is greater than the second thickness value; and
wherein the polymer is screen printed, digitally printed, laser sintered, or extruded onto the first layer of fabric.

2. The brassiere of claim 1 further comprising:
a second layer of fabric positioned against an inner surface of the first layer of fabric and the concealer, the first layer of fabric and the second layer of fabric coupled via an attachment mechanism;
wherein the first layer of fabric and the second layer of fabric surround the concealer; and
wherein the concealer is coupled to a surface of the second layer of fabric.

3. The brassiere of claim 1, wherein each of the first breast cup and the second breast cup further includes an apex region, and wherein the concealer is positioned at or proximate to the apex region.

4. The brassiere of claim 1, wherein the polymer comprises at least one of urethane, polyurethane, silicone, or plastisol.

5. The brassiere of claim 1, wherein the first thickness value is less than about 3 mm, the second thickness value is about zero millimeters, and the body of the concealer tapers from the center to the periphery.

6. The brassiere of claim 1, wherein the center of the concealer is provided in a form of a substantially circular shape, a substantially ovular shape, or a substantially elliptical shape and wherein the periphery of the concealer is provided in the form of a substantially irregular, non-circular pattern.

7. The brassiere of claim 1, wherein, after the polymer is applied to the first layer of fabric, the polymer is laser sintered by a laser sintering apparatus, and wherein the laser sintering couples the polymer to the first layer of fabric.

8. A breast cup for a brassiere, the breast cup comprising:
a first fabric layer; and
a concealer comprising a polymer composition and coupled to the first fabric layer,
wherein the concealer is provided in a form of a body having a first thickness value proximate or adjacent to a center of the body and a second thickness value proximate or adjacent to a periphery of the body.

9. The breast cup of claim 8, wherein the first thickness value is about the same or greater than the second thickness value.

10. The breast cup of claim 8, wherein a thickness of the concealer tapers from the first thickness value to the second thickness value or from the second thickness value to the first thickness value.

11. The breast cup of claim 8, wherein the center of the concealer is provided as a first shape and the periphery of the concealer is provided as a second shape different from the first shape.

12. The breast cup of claim 11, wherein the body of the concealer further comprises a plurality of first protrusions having a first length and a plurality of second protrusions having a second length, wherein first ends of the plurality of first protrusions and second ends of the plurality of second protrusions have gaps positioned therebetween, and wherein the gaps are substantially devoid of the polymer composition.

13. The breast cup of claim 8, wherein the body of the concealer includes voids substantially free of the polymer composition, and wherein a density of the voids increases from the center and towards the periphery of the body.

14. The breast cup of claim 8 further comprising:
a second fabric layer comprising an inner surface and an outer surface;
wherein the inner surface of the second fabric layer is coupled to an inner surface of the first fabric layer via stitching, bonding, or an adhesive; and
wherein the concealer is coupled to the inner surface of the second fabric layer at or near an apex region of the breast cup.

15. A method of forming a breast cup for a brassiere, the method comprising:
providing a first fabric layer, the first fabric layer including an outer surface and an inner surface;
providing a polymer;
applying a concealer to the outer surface or the inner surface of the first fabric layer; and
curing the polymer to couple the polymer to the outer surface or the inner surface of the first fabric layer.

16. The method of claim 15, wherein the polymer is applied to the outer surface or the inner surface of the first fabric layer with a varying thickness.

17. The method of claim 15 further comprising coupling a second fabric layer to the first fabric layer, wherein the first fabric layer and the second fabric layer substantially surround the concealer after the second fabric layer is coupled to the first fabric layer.

18. The method of claim 15, wherein
after the polymer is applied to the outer surface or the inner surface of the first fabric layer, or after the polymer is cured, the polymer has a first thickness value near a center portion of the polymer and a second thickness value near a periphery of the polymer, and
the polymer tapers from the first thickness value to the second thickness value.

19. The method of claim 15 further comprising:
providing a center portion of the concealer in a first pattern and a periphery of the concealer in a second pattern; and
wherein the first pattern is substantially elliptical or substantially ovular, and wherein the second pattern is substantially irregular.

20. The method of claim 18 further comprising:
providing a laser sintering apparatus including a polymer coater and a sintering laser, the polymer coater adapted to retain the polymer until the polymer is applied to the first fabric layer;
wherein the step of providing the polymer is carried out by the polymer coater; and
wherein the polymer is cured when a laser of the sintering laser strikes the polymer.
